(19) United States
(12) Patent Application Publication
(10) Pub. No.: US 2021/0200971 A1
(43) Pub. Date: Jul. 1, 2021

(54) IMAGE PROCESSING METHOD AND APPARATUS

(71) Applicants: Beijing Jingdong Shangke Information Technology Co., Ltd., Beijing (CN); Beijing Jingdong Century Trading Co., Ltd., Beijing (CN)

(72) Inventors: Guangfu Che, Beijing (CN); Shan An, Beijing (CN); Xiaozhen Ma, Beijing (CN); Yu Chen, Beijing (CN)

(73) Assignees: Beijing Jingdong Shangke Information Technology Co., Ltd., Beijing (CN); Beijing Jingdong Century Trading Co., Ltd., Beijing (CN)

(21) Appl. No.: 16/754,244

(22) PCT Filed: Sep. 30, 2018
(86) PCT No.: PCT/CN2018/109120

§ 371 Date: Apr. 7, 2020

(30) Foreign Application Priority Data
Oct. 25, 2017 (CN) 201711013332.3

(51) Int. Cl. G06K 7/14; G06T 5/40; G06T 5/00

(52) U.S. Cl. CPC G06K 7/1443; G06T 5/002; G06T 5/40; G06K 7/1452

(57) ABSTRACT

Disclosed are an image processing method and apparatus. The method may include: inputting a target image into a pre-trained image detection model to obtain a feature value of a rectangular box in which each graphic of at least one graphic presented by the target image is located, and a probability value of each graphic being a specified graphic code; in response to determining at least two rectangular boxes having regions partially overlapped in the rectangular box involved in the at least one graphic, determining a ratio of an area of partially overlapped regions enclosed by the at least two rectangular boxes to the sum of the areas of the regions enclosed by the at least two rectangular boxes; based on the comparison between the ratio and a preset ratio threshold value, determining a target rectangular box from the at least two rectangular boxes; and generating a processed target image.

### CROSS-REFERENCE TO RELATED APPLICATIONS

This application claims priority to Chinese Patent Application No. 201711013332.3, filed on Oct. 25, 2017, with applicants of Beijing Jingdong Shangke Information Technology Co., Ltd. and Beijing Jingdong Century Trading Co., Ltd., and entitled “Image Processing Method and Apparatus,” the content of which is incorporated herein by reference in its entirety.

### TECHNICAL FIELD

Embodiments of the present disclosure relate to the field of computer technologies, specifically to the field of Internet technologies, and more specifically to a method and apparatus for image processing.

### BACKGROUND

A graphic code is a black and white graphic that is distributed on a plane with a certain geometric figure according to certain rules. The graphic code can store information and is widely used in daily life. Specifically, the graphic code may be a two-dimensional code, a barcode, or the like.

### SUMMARY

An objective of embodiments of the present disclosure is to provide a method and apparatus for image processing.

In a first aspect, an embodiment of the present disclosure provides a method for image processing, the method includes: inputting a target image into a pre-trained image detection model to obtain a feature value of a rectangular box in which each graphic of at least one graphic presented by the target image is located, and a probability value of each graphic being a specified graphic code, the image detection model representing a corresponding relationship between the image, the feature value of the rectangular box in which the graphic presented by the image is located, and the probability value of the graphic being the specified graphic code; determining, in response to determining at least two rectangular boxes having regions partially overlapped in the rectangular box involved in the at least one graphic, a ratio of an area of partially overlapped regions enclosed by the at least two rectangular boxes to a sum of areas of the regions enclosed by the at least two rectangular boxes; determining a target rectangular box from the at least two rectangular boxes based on a comparison between the ratio and a preset ratio threshold; and performing blurring processing or occlusion processing on a region enclosed by the target rectangular box to generate a processed target image.

In some embodiments, before the performing blurring processing or occlusion processing on a region enclosed by the target rectangular box to generate a processed target image, the method further includes: inputting the target rectangular box into a previously trained binary classification model to determine whether a graphic in the target rectangular box is the specified graphic code, wherein the binary classification model is for determining whether the graphic in the rectangular box is the specified graphic code.

In some embodiments, the binary classification model is obtained through following steps: acquiring a first preset number of images presenting the specified graphic code as a positive sample, and acquiring a second preset number of images presenting a preset graphic as a negative sample; and extracting a histogram of oriented gradient feature vector of the positive sample and a histogram of oriented gradient feature vector of the negative sample, and inputting the extracted histogram of oriented gradient feature vectors into a radial basis function for training.

In some embodiments, the determining a ratio of an area of partially overlapped regions enclosed by the at least two rectangular boxes to a sum of areas of the regions enclosed by the at least two rectangular boxes, includes: determining an area of an intersection and an area of a union of the regions enclosed by the at least two rectangular boxes partially overlapping, and determining a ratio of the area of the intersection to the area of the union.

In some embodiments, the determining a target rectangular box from the at least two rectangular boxes based on a comparison between the ratio and a preset ratio threshold, includes: determining, in response to determining that the ratio is greater than or equal to the preset ratio threshold, a rectangular box with a highest corresponding probability value as the target rectangular box; and determining, in response to determining that the ratio is less than the preset ratio threshold, each rectangular box of the at least two rectangular boxes as the target rectangular box.

In some embodiments, the performing blurring processing or occlusion processing on a region enclosed by the target rectangular box to generate a processed target image, includes: dividing the region enclosed by the target rectangular box into a preset number of grids; and setting a pixel of each grid randomly to generate the processed target image.

In a second aspect, an embodiment of the present disclosure provides an apparatus for image processing, the apparatus includes: an input unit, configured to input a target image into a pre-trained image detection model to obtain a feature value of a rectangular box in which each graphic of at least one graphic presented by the target image is located, and a probability value of each graphic being a specified graphic code, the image detection model representing a corresponding relationship between the image, the feature value of the rectangular box in which the graphic presented by the image is located, and the probability value of the graphic being the specified graphic code; a determination unit, configured to determine, in response to determining at least two rectangular boxes having regions partially overlapped in the rectangular box involved in the at least one graphic, a ratio of an area of partially overlapped regions enclosed by the at least two rectangular boxes to a sum of areas of the regions enclosed by the at least two rectangular boxes; a comparison unit, configured to determine a target rectangular box from the at least two rectangular boxes based on a comparison between the ratio and a preset ratio threshold; and a processing unit, configured to perform blurring processing or occlusion processing on a region enclosed by the target rectangular box to generate a processed target image.

In some embodiments, the apparatus further includes: a graphic code determining unit, configured to input the target rectangular box into a previously trained binary classification model to determine whether a graphic in the target rectangular box is the specified graphic code, wherein the binary classification model is for determining whether the graphic in the rectangular box is the specified graphic code.

In some embodiments, the binary classification model is obtained through following steps: acquiring a first preset number of images presenting the specified graphic code as a positive sample, and acquiring a second preset number of images presenting a preset graphic as a negative sample; and extracting a histogram of oriented gradient feature vector of the positive sample and a histogram of oriented gradient feature vector of the negative sample, and inputting the extracted histogram of oriented gradient feature vectors into a radial basis function for training.

In some embodiments, the determination unit is further configured to: determine an area of an intersection and an area of a union of the regions enclosed by the at least two rectangular boxes partially overlapping, and determine a ratio of the area of the intersection to the area of the union.

In some embodiments, the comparison unit includes: a first determination module, configured to determine, in response to determining that the ratio is greater than or equal to the preset ratio threshold, a rectangular box with a highest corresponding probability value as the target rectangular box; and a second determination module, configured to determine, in response to determining that the ratio is less than the preset ratio threshold, each rectangular box of the at least two rectangular boxes as the target rectangular box.

In some embodiments, the processing unit includes: a dividing module, configured to divide the region enclosed by the target rectangular box into a preset number of grids; and a setting module, configured to set a pixel of each grid randomly to generate the processed target image.

In a third aspect, an embodiment of the present disclosure provides a server, the server including: one or more processors; and a storage apparatus, for storing one or more programs, where the one or more programs, when executed by the one or more processors, cause the one or more processors to implement any embodiment of the method for image processing.

In a fourth aspect, an embodiment of the present disclosure provides a computer readable storage medium, storing a computer program thereon, where the computer program, when executed by a processor, implements any embodiment of the method for image processing.

The method and apparatus for image processing provided by embodiments of the present disclosure, first inputting a target image into a pre-trained image detection model to obtain a feature value of a rectangular box in which each graphic of at least one graphic presented by the target image is located and a probability value of each graphic being a specified graphic code, the image detection model representing a corresponding relationship between the image, the feature value of the rectangular box in which the graphic presented by the image is located, and the probability value of the graphic being the specified graphic code; after that, determining, in response to determining at least two rectangular boxes having regions partially overlapped in the rectangular box involved in the at least one graphic, a ratio of an area of partially overlapped regions enclosed by the at least two rectangular boxes to a sum of areas of the regions enclosed by the at least two rectangular boxes; then, determining a target rectangular box from the at least two rectangular boxes based on a comparison between the ratio and a preset ratio threshold; and finally performing blurring processing or occlusion processing on a region enclosed by the target rectangular box to generate a processed target image, thereby improving the accuracy of determining a graphic code, and can process a graphic code in an image, thus avoiding harmful effects caused by the graphic code.

### BRIEF DESCRIPTION OF THE DRAWINGS

By reading the detailed description of non-limiting embodiments with reference to the following accompanying drawings, other features, objectives and advantages of the present disclosure will become more apparent.

FIG. 1 is a diagram of an example system architecture in which embodiments of the present disclosure may be implemented;

FIG. 2 is a flowchart of a method for image processing according to an embodiment of the present disclosure;

FIG. 3 is a schematic diagram of an application scenario of the method for image processing according to an embodiment of the present disclosure;

FIG. 4 is a flowchart of the method for image processing according to another embodiment of the present disclosure;

FIG. 5 is a schematic structural diagram of an apparatus for image processing according to an embodiment of the present disclosure; and

FIG. 6 is a schematic structural diagram of a computer system adapted to implement a server according to an embodiment of the present disclosure.

### DETAILED DESCRIPTION OF EMBODIMENTS

Embodiments of present disclosure will be described below in detail with reference to the accompanying drawings. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that some embodiments in the present disclosure and some features in the disclosure may be combined with each other on a non-conflict basis. Features of the present disclosure will be described below in detail with reference to the accompanying drawings and in combination with embodiments.

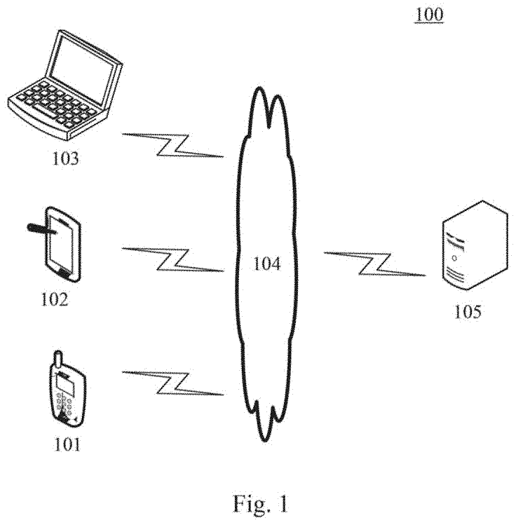

FIG. 1 illustrates an example system architecture 100 in which a method for image processing or an apparatus for image processing of embodiments of the present disclosure may be implemented.

As shown in FIG. 1, the system architecture 100 may include terminal devices 101, 102, 103, a network 104, and a server 105. The network 104 serves as a medium providing a communication link medium between the terminal devices 101, 102, 103 and the server 105. The network 104 may include various types of connections, such as wired or wireless communication links, or optic fibers.

A user may interact with the server 105 through the network 104 using the terminal devices 101, 102, 103, to receive or send messages or the like. Various communication client applications may be installed on the terminal devices 101, 102, 103, such as image display applications, shopping applications, search applications, instant messaging tools, mailbox clients, or social platform software.

The terminal devices 101, 102, 103 may be various electronic devices having display screens and supporting image display, including but not limited to smart phones, tablet computers, e-book readers, MP3 players (Moving Picture Experts Group Audio Layer III), MP4 (Moving Picture Experts Group Audio Layer IV) players, laptops computers and desktop computers, etc.

The server 105 may be a server providing various services, such as a backend server that provides support for an image displayed on the terminal devices 101, 102, and 103. The backend server may perform detection and other processing on the received image, and feed back a processing result to the terminal devices.

It should be noted that the method for image processing provided by embodiments of the present disclosure is generally performed by the server 105. Accordingly, the apparatus for image processing is generally provided in the server 105.

It should be understood that the numbers of terminal devices, networks, and servers in FIG. 1 are merely illustrative. Depending on the implementation needs, there may be any number of terminal devices, networks, and servers.

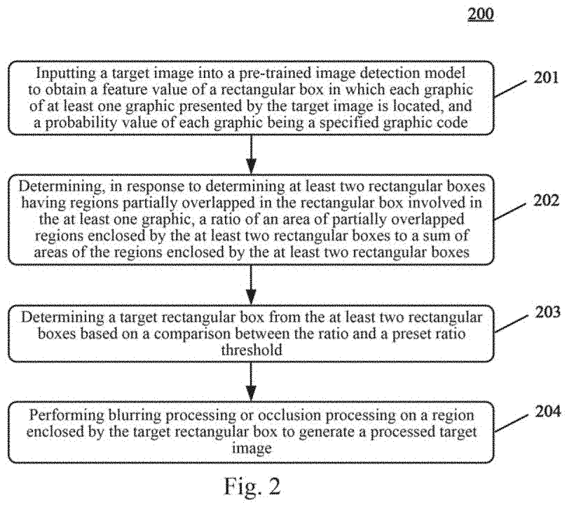

With further reference to FIG. 2, a flow 200 of a method for image processing according to an embodiment of the present disclosure is illustrated. The method for image processing includes the following steps.

Step 201, inputting a target image into a pre-trained image detection model to obtain a feature value of a rectangular box in which each graphic of at least one graphic presented by the target image is located, and a probability value of each graphic being a specified graphic code.

In the present embodiment, an electronic device (such as the server shown in FIG. 1) on which the method for image processing is performed may detect the target image by using the pre-trained image detection model, that is, input the target image into the image detection model, to obtain the feature value of the rectangular box in which each graphic of the at least one graphic presented by the target image is located and obtain the probability value of each graphic being the specified graphic code. Here, the feature value of the rectangular box in which each graphic is located and the probability value of the graphic being the specified graphic code may be outputted in pairs. The target image is an image set manually or by a machine. The image detection model may detect the image, and is used to represent a corresponding relationship between the image, the feature value of the rectangular box in which the graphic presented by the image is located, and the probability value of the graphic being the specified graphic code. The image detection model represents the corresponding relationship between the image, the feature value, and the probability value. The rectangular box is a rectangular box used to delineate a graphic in an image. The feature value of the rectangular box may be only a coordinate value, or a coordinate value and an area value, or a coordinate value and a length value, a width value, and the like. Specifically, if the feature value includes only a coordinate value, the coordinate value may be the coordinate values of the vertices of the rectangular box and the coordinate value of the center position of the rectangular box. If the feature value includes not only the coordinate value, but also the area value or the length value, the width value, the feature value may be the coordinate value of anyone of the vertices of the rectangular box or the coordinate value of the center position. Here, the graphic may be various graphics. The specified graphic code is a graphic code set manually or by a machine, and may include a two-dimensional code or a barcode.

Specifically, the image detection model may be a corresponding relationship table representing the above correspondence relationship. For example, for an image presenting one or a group of graphics, for each graphic in the image, the graphic corresponds to one or a group of feature values of the rectangular box in which the graphic is located, and corresponds to a probability value of the graphic being the specified graphic code.

In addition, the image detection model may also be a convolutional neural network model after image training. The convolutional neural network model may include two parts: an image classification model and a multi-scale convolutional layer. That is, the image classification model is used as the basic network structure of the convolutional neural network, and the convolution layer is added on this basis. When applying the convolutional neural network, an image is inputted to the part of the image classification model of the convolutional neural network. Data obtained from the image classification model passes through the multi-scale convolutional layer, reaches a fully-connected layer, and is finally outputted from the model. The image classification model may use one of a variety of models (such as VGG model, AlexNet model, or LeNet model).

Specifically, the image detection model may be constructed using the following method: selecting a plurality of images presenting the specified graphic code, and detecting and marking manually or by a machine a rectangular box region in which the specified graphic code is located; determining manually or in a preset method a feature value and a probability value corresponding to the marked image; training, using the image as input and the determined feature value and probability value as output, to obtain the image detection model. In order to obtain a more accurate model output, a sample set including a large number of samples may be used to further train the obtained image detection model.

Step 202, determining, in response to determining at least two rectangular boxes having regions partially overlapped in the rectangular box involved in the at least one graphic, a ratio of an area of partially overlapped regions enclosed by the at least two rectangular boxes to a sum of areas of the regions enclosed by the at least two rectangular boxes.

In the present embodiment, after determining that there are at least two rectangular boxes having regions partially overlapped in the rectangular box involved in the at least one graphic, the electronic device responds: determining the ratio of the area of partially overlapped regions enclosed by the at least two rectangular boxes to the sum of the areas of the regions enclosed by the at least two rectangular boxes. If the above feature value is an area, the feature value may be directly used as the area enclosed by the rectangular box. If the feature value includes a length value, a width value, or a coordinate value, the area enclosed by the rectangular box may be calculated based on the feature value. The area partially overlapped may be determined based on the coordinate value in the feature value. The at least one graphic referred to here relates to at least one rectangular box, each graphic is located in a rectangular box of the at least one rectangular box, and the graphic has a one-to-one corresponding relationship with the rectangular box.

In practice, partially overlapping may take various forms. For example, it may be in more than two rectangular boxes, and one of the rectangular boxes overlaps with the other rectangular boxes, respectively. It may also be that two or more rectangular boxes overlap among the rectangular boxes in the image.

Step 203, determining a target rectangular box from the at least two rectangular boxes based on a comparison between the ratio and a preset ratio threshold.

In the present embodiment, the electronic device compares the obtained ratio with a preset ratio threshold, and determines the target rectangular box from the at least two rectangular boxes based on the comparison. The preset ratio threshold is a threshold that is preset for a ratio and serves as a numerical limit. One target rectangular box or a plurality of target rectangular boxes may be determined from the at least two rectangular boxes.

Specifically, according to the comparison, different determination results may be obtained when the ratio is greater than, less than, or equal to the preset ratio threshold. For example, when the ratio is greater than the preset ratio threshold, the probability values of the at least two rectangular boxes are compared, and two rectangular boxes with the highest corresponding probability values are used as the target rectangular boxes. The probability value corresponding to the rectangular box is the probability value of the graphic in the rectangular box being the specified graphic code.

In some alternative implementations of the present embodiment, in response to determining that the ratio is greater than or equal to the preset ratio threshold, a rectangular box with a highest corresponding probability value is determined as the target rectangular box.

In response to determining that the ratio is less than the preset ratio threshold, each rectangular box of the at least two rectangular boxes is determined as the target rectangular box.

Step 204, performing blurring processing or occlusion processing on a region enclosed by the target rectangular box to generate a processed target image.

In the present embodiment, the electronic device performs blurring processing on the obtained target rectangular box, and may also perform occlusion processing. After performing the above processing on the target rectangular box in the target image, the processed target image is obtained. Regardless of the blurring process or the occlusion process, the objective is to make the graphic code in the target rectangular box in the target image unrecognizable, so as to prevent the graphic code from being used by others.

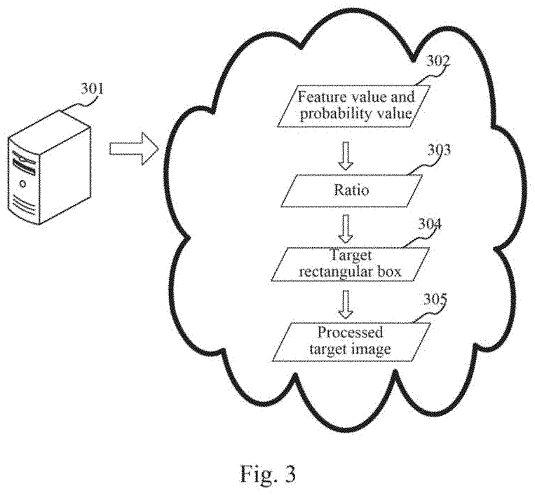

With further reference to FIG. 3, FIG. 3 is a schematic diagram of an application scenario of the method for image processing according to the present embodiment. In the application scenario of FIG. 3, an electronic device 301 inputs an image a into a pre-trained image detection model to obtain a feature value of a rectangular box in which each graphic of 4 graphics presented by the image a is located and a probability value 302 of each graphic being a specified graphic code. The image detection model is used to represent a corresponding relationship between the image, the feature value of the rectangular box in which the graphic presented by the image is located, and the probability value of the graphic being the specified graphic code. In response to determining that there are three rectangular boxes having regions partially overlapped in the rectangular boxes involved in the 4 graphics: A, B, and C, the electronic device 301 determines a ratio 303 of an area of partially overlapped regions enclosed by A, B, and C to a sum of areas of the regions enclosed by A, B, and C, determines A as a target rectangular box 304 from A, B, and C based on a comparison between the ratio and a preset ratio threshold, and performs blurring processing or occlusion processing on a region enclosed by A to generate a processed target image 305.

The method provided by the above embodiment of the present disclosure improves the accuracy of determining a graphic code, and can process the graphic code in an image, thus avoiding harmful effects caused by the graphic code.

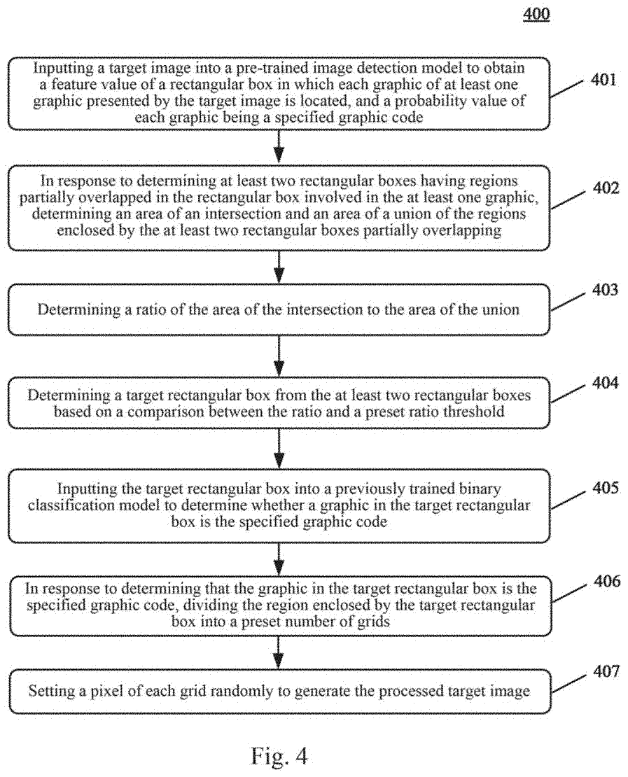

With further reference to FIG. 4, a flow 400 of another embodiment of the method for image processing is illustrated. The flow 400 of the method for image processing includes the following steps.

Step 401, inputting a target image into a pre-trained image detection model to obtain a feature value of a rectangular box in which each graphic of at least one graphic presented by the target image is located, and a probability value of each graphic being a specified graphic code.

In the present embodiment, a server on which the method for image processing is performed may detect the target image by using the pre-trained image detection model, that is, input the target image into the image detection model, to obtain the feature value of the rectangular box in which each graphic of the at least one graphic presented by the target image is located and obtain the probability value of each graphic being the specified graphic code. Here, the feature value of the rectangular box in which each graphic is located and the probability value of each graphic being the specified graphic code may be outputted in pairs. The image detection model may detect the image, and is used to represent a corresponding relationship between the image, the feature value of the rectangular box in which the graphic presented by the image is located, and the probability value of the graphic being the specified graphic code. Here, the image detection model establishes the corresponding relationship between the image, the feature value, and the probability value. The feature value of the rectangular box may be a coordinate value, may also include an area value, a length value, a width value, and the like, and may also include some of the above types. The graphic may be a two-dimensional code or a barcode.

In some alternative implementations of the present embodiment, the feature value includes the coordinate value of the center position of the rectangular box, and the length value and the width value of the rectangular box.

Step 402, in response to determining at least two rectangular boxes having regions partially overlapped in the rectangular box involved in the at least one graphic, determining an area of an intersection and an area of a union of the regions enclosed by the at least two rectangular boxes partially overlapping.

In the present embodiment, after determining that there are at least two rectangular boxes having regions partially overlapped in the rectangular box involved in the at least one graphic, the server determines the area of the intersection and the area of the union of the regions enclosed by the at least two rectangular boxes partially overlapping.

Step 403, determining a ratio of the area of the intersection to the area of the union.

In the present embodiment, after obtaining the area of the intersection and the area of the union, the server may determine the ratio of the area of the intersection to the area of the union.

Step 404, determining a target rectangular box from the at least two rectangular boxes based on a comparison between the ratio and a preset ratio threshold.

In the present embodiment, the server determines the target rectangular box from the at least two rectangular boxes based on the comparison between the obtained ratio and the preset ratio threshold. The preset ratio threshold is a threshold that is preset for a ratio. One target rectangular box or a plurality of target rectangular boxes may be determined from the at least two rectangular boxes.

Specifically, according to the comparison, different determination results may be obtained when the ratio is greater than, less than, or equal to the preset ratio threshold. For example, when the ratio is greater than the preset ratio threshold, the probability values of the at least two rectangular boxes are compared, and two rectangular boxes with the highest corresponding probability values are used as the target rectangular boxes. The probability value corresponding to the rectangular box is the probability value of the graphic in the rectangular box being the specified graphic code.

In some alternative implementations of the present embodiment, in response to determining that the ratio is greater than or equal to the preset ratio threshold, a rectangular box with a highest corresponding probability value is determined as the target rectangular box.

In response to determining that the ratio is less than the preset ratio threshold, each rectangular box of the at least two rectangular boxes is determined as the target rectangular box.

Step 405, inputting the target rectangular box into a previously trained binary classification model to determine whether a graphic in the target rectangular box is the specified graphic code.

In the present embodiment, the server inputs the target rectangular box into the previously trained binary classification model. After the model outputs whether the graphic in the target rectangular box is the specified graphic code, the server may determine whether the graphic in the target rectangular box is the specified graphic code according to the output. Here, the binary classification model is for determining whether the graphic in the rectangular box is the specified graphic code.

In some alternative implementations of the present embodiment, the binary classification model is obtained through the following steps.

A first preset number of images presenting the specified graphic code is acquired as a positive sample, and a second preset number of images presenting a preset graphic is acquired as a negative sample.

A histogram of oriented gradient feature vector of the positive sample and a histogram of oriented gradient feature vector of the negative sample are extracted, and the extracted histogram of oriented gradient feature vectors are inputted into a radial basis function for training.

In the present embodiment, the server acquires the first preset number of images as the positive sample, and the specified graphic code is presented in the positive sample. In addition, the server acquires the second preset number of images presenting the preset graphic as the negative sample. The preset graphic in the negative sample here may be various graphics different from the specified graphic code. The preset graphic may be a graphic similar to the specified graphic code, such as a graphic composed of a plurality of vertical stripes similar to a barcode.

In practice, it is required to input the extracted histogram of oriented gradient (HOG) feature vector of the positive sample and the histogram of oriented gradient feature vector of the negative sample into a support vector machine (SVM) model for training. The kernel function of the SVM model may be the radial basis function (RBF).

Step 406, in response to determining that the graphic in the target rectangular box is the specified graphic code, dividing the region enclosed by the target rectangular box into a preset number of grids.

In the present embodiment, after determining that the graphic in the target rectangular box is the specified graphic code, the server responds: dividing the region enclosed by the target rectangular box into a preset number of grids, so that the enclosed region may be refined according to the grids.

Step 407, setting a pixel of each grid randomly to generate the processed target image.

In the present embodiment, the server sets the pixel of each grid randomly to generate the processed target image. This increases the difficulty in identifying the graphic code in the rectangular box.

In the present embodiment, by randomly setting the pixel of the grid, the possibility that the graphic code in the processed target image is parsed can be reduced to further prevent the graphic code from being used by others.

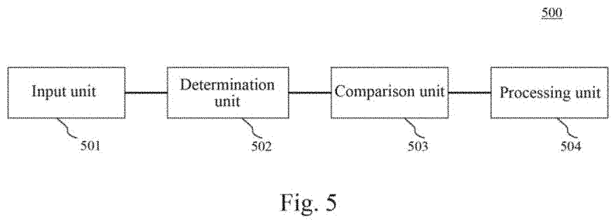

With further reference to FIG. 5, as an implementation of the method shown in the above figures, an embodiment of the present disclosure provides an apparatus for image processing, and the apparatus embodiment corresponds to the method embodiment as shown in FIG. 2. The apparatus may be specifically applied to various electronic devices.

As shown in FIG. 5, an apparatus 500 for image processing of the present embodiment includes: an input unit 501, a determination unit 502, a comparison unit 503, and a processing unit 504. The input unit 501 is configured to input a target image into a pre-trained image detection model to obtain a feature value of a rectangular box in which each graphic of at least one graphic presented by the target image is located, and a probability value of each graphic being a specified graphic code, the image detection model representing a corresponding relationship between the image, the feature value of the rectangular box in which the graphic presented by the image is located, and the probability value of the graphic being the specified graphic code. The determination unit 502 is configured to determine, in response to determining at least two rectangular boxes having regions partially overlapped in the rectangular box involved in the at least one graphic, a ratio of an area of partially overlapped regions enclosed by the at least two rectangular boxes to a sum of areas of the regions enclosed by the at least two rectangular boxes. The comparison unit 503 is configured to determine a target rectangular box from the at least two rectangular boxes based on a comparison between the ratio and a preset ratio threshold. The processing unit 504 is configured to perform blurring processing or occlusion processing on a region enclosed by the target rectangular box to generate a processed target image.

In the present embodiment, an electronic device (such as the server shown in FIG. 1) on which the method for image processing is performed may detect the target image by using the pre-trained image detection model, that is, input the target image into the image detection model, to obtain the feature value of the rectangular box in which each graphic of the at least one graphic presented by the target image is located and obtain the probability value of each graphic being the specified graphic code. Here, the feature value of the rectangular box in which each graphic is located and the probability value of the graphic being the specified graphic code may be outputted in pairs. The image detection model may detect the image, and is used to represent a corresponding relationship between the image, the feature value of the rectangular box in which the graphic presented by the image is located, and the probability value of the graphic being the specified graphic code. Here, the image detection model establishes the corresponding relationship between the image, the feature value, and the probability value. The feature value of the rectangular box may be a coordinate value, may also include an area value, a length value, a width value, and the like, and may also include some of the above types. The graphic may be various graphics. The specified graphic code is a graphic code set manually or by a machine, and may include a two-dimensional code or a barcode.

In the present embodiment, after determining at least two rectangular boxes having regions partially overlapped in the rectangular box involved in the at least one graphic, the electronic device responds: determining the ratio of the area of partially overlapped regions enclosed by the at least two rectangular boxes to the sum of the areas of the regions enclosed by the at least two rectangular boxes. If the above feature value is an area, the feature value may be directly used as the area enclosed by the rectangular box. If the feature value is a length value, a width value, or a coordinate value (coordinate values of the vertices of the rectangular box and/or the coordinate value of the center position of the rectangular box), the area enclosed by the rectangular box may be calculated based on the feature value. The at least one graphic referred to here relates to at least one rectangular box, each graphic is located in a rectangular box of the at least one rectangular box, and the graphic has a one-to-one corresponding relationship with the rectangular box.

In the present embodiment, the electronic device compares the obtained ratio with a preset ratio threshold, and determines the target rectangular box from the at least two rectangular boxes based on the comparison. The preset ratio threshold is a threshold that is preset for a ratio. One target rectangular box or a plurality of target rectangular boxes may be determined from the at least two rectangular boxes.

In the present embodiment, the electronic device performs blurring processing on the obtained target rectangular box, and may also perform occlusion processing. After performing the above processing on the target rectangular box in the target image, the processed target image is obtained. Regardless of the blurring process or the occlusion process, the objective is to make the graphic code in the target rectangular box in the target image unrecognizable, so as to prevent the graphic code from being used by others.

In some alternative implementations of the present embodiment, the apparatus further includes: a graphic code determining unit, configured to input the target rectangular box into a previously trained binary classification model to determine whether a graphic in the target rectangular box is the specified graphic code, where the binary classification model is for determining whether the graphic in the rectangular box is the specified graphic code.

In some alternative implementations of the present embodiment, the binary classification model is obtained through the following steps: acquiring a first preset number of images presenting the specified graphic code as a positive sample, and acquiring a second preset number of images presenting a preset graphic as a negative sample; and extracting a histogram of oriented gradient feature vector of the positive sample and a histogram of oriented gradient feature vector of the negative sample, and inputting the extracted histogram of oriented gradient feature vectors into a radial basis function for training.

In some alternative implementations of the present embodiment, the determination unit is further configured to:

determine an area of an intersection and an area of a union of the regions enclosed by the at least two rectangular boxes partially overlapping, and determine a ratio of the area of the intersection to the area of the union.

In some alternative implementations of the present embodiment, the comparison unit includes: a first determination module, configured to determine, in response to determining that the ratio is greater than or equal to the preset ratio threshold, a rectangular box with a highest corresponding probability value as the target rectangular box; and a second determination module, configured to determine, in response to determining that the ratio is less than the preset ratio threshold, each rectangular box of the at least two rectangular boxes as the target rectangular box.

In some alternative implementations of the present embodiment, the processing unit includes: a dividing module, configured to divide the region enclosed by the target rectangular box into a preset number of grids; and a setting module, configured to set a pixel of each grid randomly to generate the processed target image.

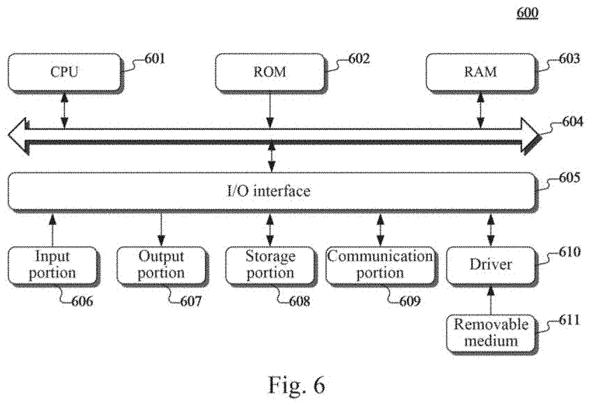

With further reference to FIG. 6, a schematic structural diagram of a computer system 600 adapted to implement a server of embodiments of the present disclosure is illustrated. The server shown in FIG. 6 is merely an example and should not impose any limitation on the function and scope of use of embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including such as a keyboard, and a mouse; an output portion 607 including such as a cathode ray tube (CRT), liquid crystal display (LCD), and a speaker; the storage portion 608 including such as a hard disk; and a communication portion 609 including a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, to facilitate the retrieval of a computer program from the removable medium 611, and the installation thereof on the storage portion 608 as needed.

In particular, according to some embodiments of the present disclosure, the process described above with reference to the flow chart may be implemented in a computer software program. For example, some embodiments of the present disclosure include a computer program product, which includes a computer program that is tangibly embedded in a computer readable medium. The computer program includes program codes for executing the method as shown in the flow chart. In such an embodiment, the computer program may be downloaded and installed from a network via the communication portion 609, and/or be installed from the removable medium 611. The computer program, when executed by the central processing unit (CPU) 601, implements the above functions as defined by the method of some embodiments of the present disclosure. It should be noted that the computer readable medium according to some embodiments of the present disclosure may be a computer readable signal medium or a computer readable medium or any combination of the above two. An example of the computer readable medium may include, but is not limited to: electric, magnetic, optical, electromagnetic, infrared, or semiconductor systems, apparatuses, elements, or a combination of any of the above. A more specific example of the computer readable medium may include, but is not limited to: electrical connection with one or more pieces of wire, a portable computer disk, a hard disk, a random access memory (RAM), a read only memory (ROM), an erasable programmable read only memory (EPROM or flash memory) , an optical fiber, a portable compact disk read only memory (CD-ROM), an optical memory, a magnetic memory, or any suitable combination of the above. In some embodiments of the present disclosure, the computer readable medium may be any tangible medium containing or storing programs, which may be used by, or used in combination with, a command execution system, apparatus or element. In some embodiments of the present disclosure, the computer readable signal medium may include a data signal in the base band or propagating as apart of a carrier wave, in which computer readable program codes are carried. The propagating data signal may take various forms, including but not limited to an electromagnetic signal, an optical signal, or any suitable combination of the above. The computer readable signal medium may also be any computer readable medium except for the computer readable medium. The computer readable medium is capable of transmitting, propagating or transferring programs for use by, or used in combination with, a command execution system, apparatus or element. The program codes contained on the computer readable medium may be transmitted with any suitable medium, including but not limited to: wireless, wired, optical cable, RF medium, etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logical functions. It should be further noted that, in some alternative implementations, the functions denoted by the blocks may also occur in a sequence different from the sequences shown in the figures. For example, any two blocks presented in succession may be executed substantially in parallel, or they may sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

The units involved in embodiments of the present disclosure may be implemented by means of software or hardware. The described units may also be provided in a processor, for example, may be described as: a processor including an input unit, a determination unit, a comparison unit, and a processing unit. Here, the names of these units do not in some cases constitute limitations to such units themselves. For example, the acquiring unit may also be described as “a unit configured to input a target image into a pre-trained image detection model”.

In another aspect, embodiments of the present disclosure further provide a computer readable medium. The computer readable medium may be included in the apparatus in the above described embodiments, or a stand-alone computer readable medium not assembled into the apparatus. The computer readable medium carries one or more programs. The one or more programs, when executed by the apparatus, cause the apparatus to: input a target image into a pre-trained image detection model to obtain a feature value of a rectangular box in which each graphic of at least one graphic presented by the target image is located and a probability value of each graphic being a specified graphic code, the image detection model representing a corresponding relationship between the image, the feature value of the rectangular box in which the graphic presented by the image is located, and the probability value of the graphic being the specified graphic code; determine, in response to determining at least two rectangular boxes having regions partially overlapped in the rectangular box involved in the at least one graphic, a ratio of an area of partially overlapped regions enclosed by the at least two rectangular boxes to a sum of areas of the regions enclosed by the at least two rectangular boxes; determine a target rectangular box from the at least two rectangular boxes based on a comparison between the ratio and a preset ratio threshold; and perform blurring processing or occlusion processing on a region enclosed by the target rectangular box to generate a processed target image.

The above description only provides an explanation of embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

1. A method for image processing, the method comprising:
inputting a target image into a pre-trained image detection model to obtain a feature value of a rectangular box in which each graphic of at least one graphic presented by the target image is located, and a probability value of each graphic being a specified graphic code, the image detection model representing a corresponding relationship between the image, the feature value of the rectangular box in which the graphic presented by the image is located, and the probability value of the graphic being the specified graphic code;
determining, in response to determining at least two rectangular boxes having regions partially overlapped in the rectangular box involved in the at least one graphic, a ratio of an area of partially overlapped regions enclosed by the at least two rectangular boxes to a sum of areas of the regions enclosed by the at least two rectangular boxes;
determining a target rectangular box from the at least two rectangular boxes based on a comparison between the ratio and a preset ratio threshold; and
performing blurring processing or occlusion processing on a region enclosed by the target rectangular box to generate a processed target image.

2. The method for image processing according to claim 1, before the performing blurring processing or occlusion processing on a region enclosed by the target rectangular box to generate a processed target image, further comprising:
inputting the target rectangular box into a previously trained binary classification model to determine whether a graphic in the target rectangular box is the specified graphic code, wherein the binary classification model is for determining whether the graphic in the rectangular box is the specified graphic code.

3. The method for image processing according to claim 1, wherein the binary classification model is obtained through following steps:
acquiring a first preset number of images presenting the specified graphic code as a positive sample, and acquiring a second preset number of images presenting a preset graphic as a negative sample; and
extracting a histogram of oriented gradient feature vector of the positive sample and a histogram of oriented gradient feature vector of the negative sample, and inputting the extracted histogram of oriented gradient feature vectors into a radial basis function for training.

4. The method for image processing according to claim 1, wherein the determining a ratio of an area of partially overlapped regions enclosed by the at least two rectangular boxes to a sum of areas of the regions enclosed by the at least two rectangular boxes, comprises:
determining an area of an intersection and an area of a union of the regions enclosed by the at least two rectangular boxes partially overlapping, and determining a ratio of the area of the intersection to the area of the union.

5. The method for image processing according to claim 1, wherein the determining a target rectangular box from the at least two rectangular boxes based on a comparison between the ratio and a preset ratio threshold, comprises:
determining, in response to determining that the ratio is greater than or equal to the preset ratio threshold, a rectangular box with a highest corresponding probability value as the target rectangular box; and
determining, in response to determining that the ratio is less than the preset ratio threshold, each rectangular box of the at least two rectangular boxes as the target rectangular box.

6. The method for image processing according to claim 1, wherein the performing blurring processing or occlusion processing on a region enclosed by the target rectangular box to generate a processed target image, comprises:
dividing the region enclosed by the target rectangular box into a preset number of grids; and
setting a pixel of each grid randomly to generate the processed target image.

7. An apparatus for image processing, the apparatus comprising:
at least one processor; and
a memory storing instructions, the instructions when executed by the at least one processor, cause the at least one processor to perform operations, the operations comprising:
inputting a target image into a pre-trained image detection model to obtain a feature value of a rectangular box in which each graphic of at least one graphic presented by the target image is located, and a probability value of each graphic being a specified graphic code, the image detection model representing a corresponding relationship between the image, the feature value of the rectangular box in which the graphic presented by the image is located, and the probability value of the graphic being the specified graphic code;
determining, in response to determining at least two rectangular boxes having regions partially overlapped in the rectangular box involved in the at least one graphic, a ratio of an area of partially overlapped regions enclosed by the at least two rectangular boxes to a sum of areas of the regions enclosed by the at least two rectangular boxes;
determining a target rectangular box from the at least two rectangular boxes based on a comparison between the ratio and a preset ratio threshold; and
performing blurring processing or occlusion processing on a region enclosed by the target rectangular box to generate a processed target image.

8. The apparatus for image processing according to claim 7, before the performing blurring processing or occlusion processing on a region enclosed by the target rectangular box to generate a processed target image, the apparatus operations further comprising:
inputting the target rectangular box into a previously trained binary classification model to determine whether a graphic in the target rectangular box is the specified graphic code, wherein the binary classification model is for determining whether the graphic in the rectangular box is the specified graphic code.

9. The apparatus for image processing according to claim 7, wherein the binary classification model is obtained through following steps:
acquiring a first preset number of images presenting the specified graphic code as a positive sample, and acquiring a second preset number of images presenting a preset graphic as a negative sample; and
extracting a histogram of oriented gradient feature vector of the positive sample and a histogram of oriented gradient feature vector of the negative sample, and inputting the extracted histogram of oriented gradient feature vectors into a radial basis function for training.

10. The apparatus for image processing according to claim 7, wherein the determining a ratio of an area of partially overlapped regions enclosed by the at least two rectangular boxes to a sum of areas of the regions enclosed by the at least two rectangular boxes, comprises:
determining an area of an intersection and an area of a union of the regions enclosed by the at least two rectangular boxes partially overlapping, and determining a ratio of the area of the intersection to the area of the union.

11. The apparatus for image processing according to claim 7, wherein the determining a target rectangular box from the at least two rectangular boxes based on a comparison between the ratio and a preset ratio threshold, comprises:
determining, in response to determining that the ratio is greater than or equal to the preset ratio threshold, a rectangular box with a highest corresponding probability value as the target rectangular box; and
determining, in response to determining that the ratio is less than the preset ratio threshold, each rectangular box of the at least two rectangular boxes as the target rectangular box.

12. The apparatus for image processing according to 7, wherein the performing blurring processing or occlusion processing on a region enclosed by the target rectangular box to generate a processed target image, comprises:
dividing the region enclosed by the target rectangular box into a preset number of grids; and
setting a pixel of each grid randomly to generate the processed target image.

13. (canceled)

14. A non-transitory computer readable storage medium, storing a computer program thereon, the program, when executed by a processor, causing the processor to perform operations, the operations comprising:
inputting a target image into a pre-trained image detection model to obtain a feature value of a rectangular box in which each graphic of at least one graphic presented by the target image is located, and a probability value of each graphic being a specified graphic code, the image detection model representing a corresponding relationship between the image, the feature value of the rectangular box in which the graphic presented by the image is located, and the probability value of the graphic being the specified graphic code;
determining, in response to determining at least two rectangular boxes having regions partially overlapped in the rectangular box involved in the at least one graphic, a ratio of an area of partially overlapped regions enclosed by the at least two rectangular boxes to a sum of areas of the regions enclosed by the at least two rectangular boxes;
determining a target rectangular box from the at least two rectangular boxes based on a comparison between the ratio and a preset ratio threshold; and
performing blurring processing or occlusion processing on a region enclosed by the target rectangular box to generate a processed target image.

15. The non-transitory computer readable storage medium according to claim 14, before the performing blurring processing or occlusion processing on a region enclosed by the target rectangular box to generate a processed target image, the operations further comprising:
inputting the target rectangular box into a previously trained binary classification model to determine whether a graphic in the target rectangular box is the specified graphic code, wherein the binary classification model is for determining whether the graphic in the rectangular box is the specified graphic code.

16. The non-transitory computer readable storage medium according to claim 14, wherein the binary classification model is obtained through following steps:
acquiring a first preset number of images presenting the specified graphic code as a positive sample, and acquiring a second preset number of images presenting a preset graphic as a negative sample; and
extracting a histogram of oriented gradient feature vector of the positive sample and a histogram of oriented gradient feature vector of the negative sample, and inputting the extracted histogram of oriented gradient feature vectors into a radial basis function for training.

17. The non-transitory computer readable storage medium according to claim 14, wherein the determining a ratio of an area of partially overlapped regions enclosed by the at least two rectangular boxes to a sum of areas of the regions enclosed by the at least two rectangular boxes, comprises:
determining an area of an intersection and an area of a union of the regions enclosed by the at least two rectangular boxes partially overlapping, and determining a ratio of the area of the intersection to the area of the union.

18. The non-transitory computer readable storage medium according to claim 14, wherein the determining a target rectangular box from the at least two rectangular boxes based on a comparison between the ratio and a preset ratio threshold, comprises:
determining, in response to determining that the ratio is greater than or equal to the preset ratio threshold, a rectangular box with a highest corresponding probability value as the target rectangular box; and
determining, in response to determining that the ratio is less than the preset ratio threshold, each rectangular box of the at least two rectangular boxes as the target rectangular box.

19. The non-transitory computer readable storage medium according to claim 14, wherein the performing blurring processing or occlusion processing on a region enclosed by the target rectangular box to generate a processed target image, comprises:
dividing the region enclosed by the target rectangular box into a preset number of grids; and
setting a pixel of each grid randomly to generate the processed target image.
